(19) United States
(12) Patent Application Publication
(10) Pub. No.: US 2026/0103981 A1
(43) Pub. Date: Apr. 16, 2026

(54) PRESSURE-CONTROLLED TUNNEL DIRECTIONAL GROUTING-BASED REINFORCEMENT DEVICES

(71) Applicants: CHINA UNIVERSITY OF MINING AND TECHNOLOGY, Xuzhou (CN); SHANDONG UNIVERSITY, Jinan (CN)

(72) Inventors: Wei LI, Xuzhou (CN); Liyuan YU, Xuzhou (CN); Jiwen BAI, Jinan (CN); Haijian SU, Xuzhou (CN); Tao ZHANG, Xuzhou (CN); Peng ZHAO, Xuzhou (CN); Mengjun CHEN, Jinan (CN); Bowen HU, Xuzhou (CN); Yankai LIU, Jinan (CN); Zizheng SUN, Jinan (CN); Zhihui LIU, Jinan (CN); Hongyu SUN, Xuzhou (CN); Bing CHEN, Jinan (CN); Yuxuan PENG, Xuzhou (CN); Jiayu QIAN, Xuzhou (CN); Jingwei LIU, Xuzhou (CN)

(73) Assignees: CHINA UNIVERSITY OF MINING AND TECHNOLOGY, Xuzhou (CN); SHANDONG UNIVERSITY, Jinan (CN)

(21) Appl. No.: 19/344,448

(22) Filed: Sep. 29, 2025

(30) Foreign Application Priority Data
Oct. 10, 2024 (CN) 202411410587.3

(51) Int. Cl. E21D 11/10; E21D 9/00

(52) U.S. Cl. CPC E21D 11/105; E21D 9/002; E21D 11/107

(57) ABSTRACT

A pressure-controlled tunnel directional grouting reinforcement device is provided. Some embodiments of the present disclosure utilize the pressure generated during the concrete injection serves as a power source, and changes the directional movement of the front conical block, the rear conical block, and the actuated sleeve valve inside the interface pipe. This allows the concrete grout to be injected in a relatively low-pressure state and to be injected into an inner structural layer in a relatively low-pressure and stable state. The objective is to preserve the high-pressure state of the concrete grout during injection, and to reduce the damaging effects caused by high-pressure erosion of the concrete grout on the inner structural layer. To reduce the damaging effects of the high-pressure erosion on the inner structural layer by the concrete grout. An active pressure compensation is further employed to interfere with a pressure fluctuation state of the concrete grout.

### CROSS-REFERENCE

This application claims priority to Chinese application No. 202411410587.3 filed on Oct. 10, 2024, the entire contents of which are incorporated herein by reference.

### TECHNICAL FIELD

The present disclosure generally relates to the field of grouting reinforcement, and in particular, to a pressure-controlled tunnel directional grouting reinforcement device.

### BACKGROUND

In tunnel construction operations, the tunnel construction process primarily includes the following steps: construction of portal section and tunnel entrance, tunnel excavation and advancement, initial tunnel support, waterproofing layer construction, and secondary lining construction. Each construction step requires rigorous quality control. Using the secondary lining construction step as an illustrative example, its essential nature involves continuous pouring of concrete grout at fixed locations.

The grouting process is primarily controlled by a grouting jumbo, with computer systems assisting in the process. It should be noted that ensuring complete infusion of the concrete grout into all portions of a designated area necessitates an elevation of grouting pressure, assuming grout quality is maintained. This high-pressure state, however, introduces a risk of high-pressure erosion and potential compromise of an inner structural layer, possibly leading to the concrete grout seepage or leakage. Injection under a low-pressure condition, as an alternative, may lead to non-uniform grout distribution, thereby adversely impacting the stability of subsequent structural layers.

Therefore, a pressure-controlled tunnel directional grouting reinforcement device is provided to solve the problem that the pressure of the concrete grout affects the construction quality, thereby avoiding erosion or damage to the inner structural layer due to excessively high-pressure, and preventing uneven grout distribution due to excessively low-pressure, which affects the stability of the subsequent structural layers.

### SUMMARY

One or more embodiments of the present disclosure provide a pressure-controlled tunnel directional grouting reinforcement device. The pressure-controlled tunnel directional grouting reinforcement device is applied in a grouting jumbo and includes an interface pipe. An actuated sleeve valve is provided at a center of an interior of the interface pipe, coordinated blade sets and fixed flow vanes are provided in an inner wall of the interface pipe, respectively. An end of the actuated sleeve valve away from the coordinated blade sets extends to an outside of the interface pipe. A plurality of return claw pipes are mounted on the end of the actuated sleeve valve away from the coordinated blade sets. Both an interior of the actuated sleeve valve and an interior of each of the plurality of return claw pipes are in a hollow state. Both ends of the actuated sleeve valve and each of the plurality of return claw pipes are configured with open ports. An intermediate portion of the actuated sleeve valve, located between the coordinated blade sets and the fixed flow vanes, is mounted with a front conical block and a rear conical block respectively. A coordinated rubber ring segment corresponding to the actuated sleeve valve is mounted between the front conical block and the rear conical block. An outer position of the actuated sleeve valve corresponding to the coordinated rubber ring segment is configured as a grout discharge chamber. A grout drainage trough is arranged on an outer wall of the actuated sleeve valve corresponding to the grout discharge chamber. The front conical block and the rear conical block are sequentially arranged along a direction from the coordinated blade sets to the plurality of return claw pipes, both the front conical block and the rear conical block are slidably and fixedly connected to the actuated sleeve valve. A connecting spring is arranged on an outer position of the actuated sleeve valve between the rear conical block and the fixed flow vanes. A radial dimension of the front conical block and a radial dimension of the rear conical block are smaller than an inner diameter of the interface pipe. Each of the plurality of return claw pipes bent in a reverse direction toward the interface pipe. A compressed rubber cap is mounted on a position of the actuated sleeve valve that is between the fixed flow vanes and the plurality of return claw pipes. A cross-section of the compressed rubber cap is curved in an arch shape, and the compressed rubber cap is curved toward the plurality of return claw pipes.

In some embodiments, the coordinated blade sets are rotationally connected to the inner wall of the interface pipe, the fixed flow vanes are mounted on the inner wall of the interface pipe, and the actuated sleeve valve and the fixed flow vanes are slidably connected.

In some embodiments, a set of limit strips is mounted on an outer wall of the actuated sleeve valve corresponding to the plurality of coordinated blade sets, and the plurality of coordinated blade sets are slidably connected to the actuated sleeve valve through the set of limit strips.

In some embodiments, cross-sections of the front conical block and the rear conical block are both in a lateral conical shape, and tip portions of the front conical block and the rear conical block are away from each other.

In some embodiments, the interface pipe, along a direction from the coordinated blade sets to the plurality of return claw pipes, is provided with an injection port and a discharge port, respectively.

In some embodiments, a pressure coupled cylinder corresponding to the grout discharge chamber is mounted on an outer position of the interface pipe. An output shaft end of the pressure coupled cylinder extends into the interface pipe, passive pressure blocks are mounted on the output shaft end of the pressure coupled cylinder. The passive pressure blocks are arranged at a middle position of the coordinated rubber ring segment, and the passive pressure blocks are arranged in an annular array around a center point of the actuated sleeve valve.

In some embodiments, the device further includes a flexible sensor and a processor, the flexible sensor being configured to detect a degree of surface deformation of the coordinated rubber ring segment. The processor is configured to: determine a pressure difference based on the degree of surface deformation; determine a pressure value for active pressure compensation based on the pressure difference; and trigger the pressure coupled cylinder to perform the active pressure compensation based on the pressure value.

In some embodiments, the processor is further configured to: determine a pressure difference of a future time period based on a degree of surface deformation of a first time period; and determine the pressure value based on the pressure difference of the future time period; wherein a time length of the first time period correlates to a blockage rate of a second time period.

In some embodiments, the processor is further configured to: determine the pressure value based on a pressure sequence, an opening size of the grout drainage trough, and the pressure difference.

In some embodiments, the grout drainage trough is provided with a movable plate, the movable plate adjusting the opening size by varying a coverage area over the grout drainage trough. An interior of the grout discharge chamber is provided with a pressure sensor. The pressure sensor is configured to detect a pressure of the grout discharge chamber. The opening size is determined on the pressure of the grout discharge chamber and a grout viscosity.

In some embodiments, a first flow meter is arranged at an inlet of the grout drainage trough. The first flow meter is configured to detect a grout inflow volume. A second flow meter is arranged at an outlet of the grout drainage trough. The second flow meter is configured to detect a grout discharge volume. The processor is further configured to: determine a blockage rate of the grout drainage trough based on the grout inflow volume and the grout discharge volume; in response to determining that the blockage rate exceeds a blockage rate threshold, issue a cleanup warning; and in response to determining that the blockage rate does not exceed the blockage rate threshold, determine the opening size based on the grout inflow volume, the grout discharge volume, the pressure of the grout discharge chamber, and the grout viscosity. The blockage rate threshold correlates to a moving range of the movable plate and the grout viscosity.

In some embodiments, the processor is further configured to: determine a blockage rate of the second time period based on a grout inflow volume of a third time period, a grout discharge volume of the third time period, and an opening size of the third time period; and determine a warning time point based on the blockage rate of the second time period and the blockage rate threshold, and issue the cleanup warning at the warning time point.

### BRIEF DESCRIPTION OF THE DRAWINGS

To more clearly illustrate the embodiments of the present disclosure or the technical solutions in the prior art, the following briefly introduces the drawings required for use in the embodiments or the description of the prior art. Obviously, the drawings described below are only some embodiments of the present disclosure. For those skilled in the art, other drawings can be obtained based on these drawings without paying any creative work.

FIG. 1 is a schematic diagram of a structure of a pressure-controlled tunnel directional grouting reinforcement device according to some embodiments of the present disclosure.

FIG. 2 is a cross-sectional view of the pressure-controlled tunnel directional grouting reinforcement device in FIG. 1 according to some embodiments of the present disclosure.

FIG. 3 is a sectional view of the pressure-controlled tunnel directional grouting reinforcement device in FIG. 1 according to some embodiments of the present disclosure.

FIG. 4 is an exploded diagram of the pressure-controlled tunnel directional grouting reinforcement device in FIG. 3 according to some embodiments of the present disclosure.

FIG. 5 is a cutaway diagram of a portion of an actuated sleeve valve in the pressure-controlled tunnel directional grouting reinforcement device according to some embodiments of the present disclosure.

FIG. 6 is a schematic diagram of a structure of an actuated sleeve valve in the pressure-controlled tunnel directional grouting reinforcement device according to some embodiments of the present disclosure.

In the figures: 1, interface pipe; 101, injection port; 102, discharge port; 2, pressure coupled cylinder; 3, return claw pipe; 4, actuated sleeve valve; 5, coordinated blade set; 6, front conical block; 7, rear conical block; 8, connecting spring; 9, fixed flow vane; 10, compressed rubber cap; 11, coordinated rubber ring segment; 12, passive pressure block; 13, set of limit strips; 14, grout drainage trough; 15, flexible sensor; 16, processor; 17, movable plate; 18, pressure sensor; 19, first flow meter; 20, second flow meter.

### DETAILED DESCRIPTION

The technical solutions of the present disclosure may be clearly and completely described below in conjunction with embodiments, and the described embodiments are only part of the embodiments of the present disclosure, and not all of them. Based on the embodiments in the present disclosure, all other embodiments obtained by those skilled in the art without making any creative work shall fall within the scope of protection of the present disclosure.

In the context of the concrete grouting process during tunnel construction operations, the pressure of the concrete grout constitutes a critical factor having a direct impact on construction quality. Elevated pressure conditions introduce risks of erosion or outright failure of an inner structural layer. Conversely, inadequate pressure results in non-uniform grout distribution, thereby directly impacting the stability of subsequent structural layers. Based on this, some embodiments of the present disclosure provides a pressure-controlled tunnel directional grouting reinforcement device (hereinafter referred to as the device).

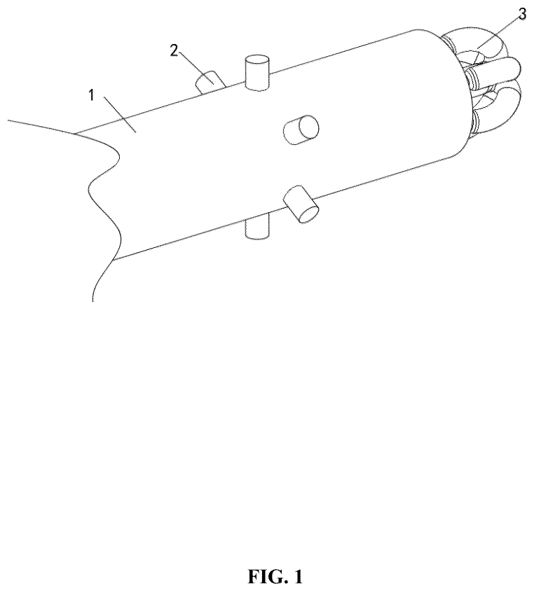

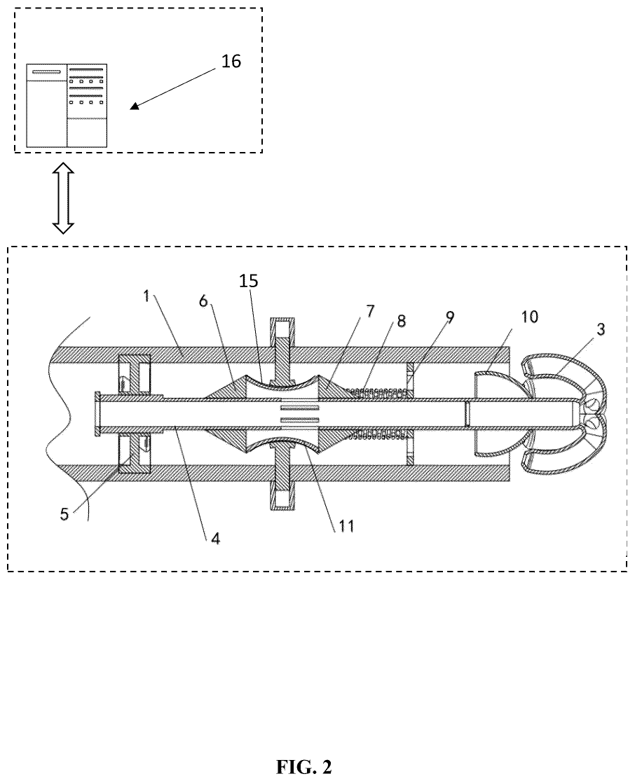

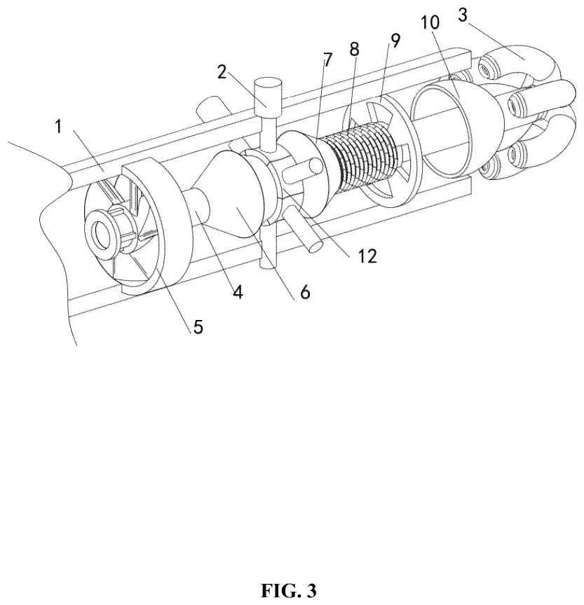

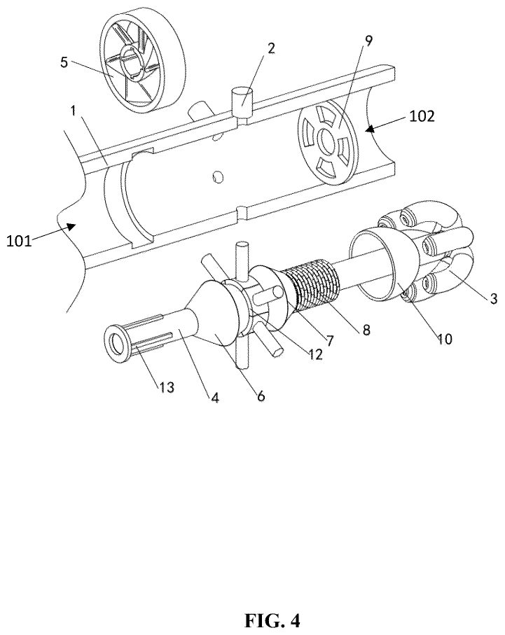

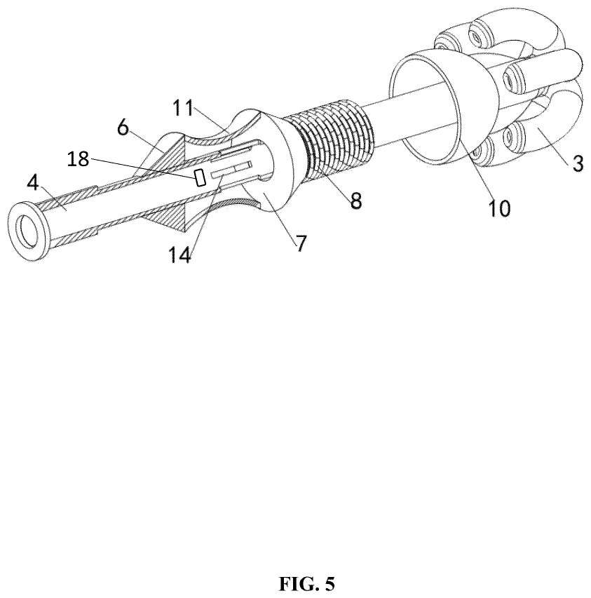

FIG. 1 is a schematic diagram of a structure of a pressure-controlled tunnel directional grouting reinforcement device according to some embodiments of the present disclosure. FIG. 2 is a cross-sectional view of the pressure-controlled tunnel directional grouting reinforcement device in FIG. 1 according to some embodiments of the present disclosure. FIG. 3 is a sectional view of the pressure-controlled tunnel directional grouting reinforcement device in FIG. 1 according to some embodiments of the present disclosure. FIG. 4 is a exploded diagram of the pressure-controlled tunnel directional grouting reinforcement device in FIG. 3 according to some embodiments of the present disclosure. FIG. 5 is a cutaway diagram of a portion of an actuated sleeve valve in the pressure-controlled tunnel directional grouting reinforcement device according to some embodiments of the present disclosure.

In some embodiments, as shown in FIG. 1-FIG. 5, the device is applied in a grouting jumbo, the device includes an interface pipe 1, an actuated sleeve valve 4 is provided at a center of an interior of the interface pipe 1, and coordinated blade sets 5 and fixed flow vanes 9 are provided in an inner wall of the interface pipe 1, respectively. An end of the actuated sleeve valve 4 away from the coordinated blade sets 5 extends to an outside of the interface pipe 1. A plurality of return claw pipes 3 are mounted on the end of the actuated sleeve valve 4 away from the coordinated blade sets 5. Both an interior of the actuated sleeve valve 4 and an interior of each of the plurality of return claw pipes 3 are in a hollow state. Both ends of the actuated sleeve valve 4 and each of the plurality of return claw pipes 3 are configured with open ports. An intermediate portion of the actuated sleeve valve 4, located between the coordinated blade sets 5 and the fixed flow vanes 9, is mounted with a front conical block 6 and a rear conical block 7 respectively. A coordinated rubber ring segment 11 corresponding to the actuated sleeve valve 4 is mounted between the front conical block 6 and the rear conical block 7. An outer position of the actuated sleeve valve 4 corresponding to the coordinated rubber ring segment 11 is configured as a grout discharge chamber. A grout drainage trough 14 is arranged on an outer wall of the actuated sleeve valve 4 corresponding to the grout discharge chamber. The front conical block 6 and the rear conical block 7 are sequentially arranged along a direction from the coordinated blade sets to the plurality of return claw pipes 3. Both the front conical block 6 and the rear conical block 7 are slidably and fixedly connected to the actuated sleeve valve 4. A connecting spring 8 is arranged on an outer position of the actuated sleeve valve 4 between the rear conical block 7 and the fixed flow vanes 9. A radial dimension of the front conical block 6 and a radial dimension of the rear conical block 7 are smaller than an inner diameter of the interface pipe 1, each of the plurality of return claw pipes 3 bent in a reverse direction toward the interface pipe 1. A compressed rubber cap 10 is mounted on a position of the actuated sleeve valve 4 that is between the fixed flow vanes 9 and the plurality of return claw pipes 3. A cross-section of the compressed rubber cap 10 is curved in an arch shape, and the compressed rubber cap 10 is curved toward the plurality of return claw pipes 3.

The grouting jumbo is a mobile complete set of equipment that integrates automatic loading, high-speed mixing, low-speed mixing, precise metering, pumping and real-time monitoring. The grouting jumbo is used for on-site preparation and high-pressure injection of concrete grout, grouting agents or chemical slurries in tunnels, bridges, mines, water conservancy projects, and other projects.

The interface pipe 1 is configured to guide the high-pressure grout (e.g., concrete grout) pumped by the grouting jumbo into the tunnel grouting hole. The interface pipe 1 may be designed in a variety of structural shapes, such as round tube shape. In some embodiments, as shown in FIG. 2, the concrete grout enters from a left position of the interface pipe 1 into a primary channel and a secondary channel, respectively. The primary channel refers to an internal channel of the actuated sleeve valve 4. The concrete grout enters the primary channel and flows directly to the plurality of return claw pipes 3. The secondary channel refers to a channel between the outer wall of the actuated sleeve valve 4 and the inner wall of the interface pipe 1. The concrete grout enters the secondary channel and flows into a space of the secondary channel.

The plurality of return claw pipes 3 is configured to allow the concrete grout in the primary channel to collide with the concrete grout in the secondary channel, offsetting the high-pressure impact and forming a uniform low-pressure output. When the pressure in a pressure discharge chamber is too high, the plurality of return claw pipes 3 may guide excess concrete grout back to the primary channel.

The actuated sleeve valve 4 is configured to transport the concrete grout within the primary channel. In some embodiments, the actuated sleeve valve 4 may change an opening degree (e.g., an opening size) of the grout drainage trough through axial displacement under the pressure of the concrete grout itself, thereby realizing adaptive adjustment of the grouting flow.

The coordinated blade set 5 is configured to be driven to rotate when the concrete grout flows through, forming a vortex to prevent the concrete grout from settling. In some embodiments, the coordinated blade set 5 is sleeved on one end (e.g., a left end as shown in FIG. 2) of the actuated sleeve valve 4.

The front conical block 6 and the rear conical block 7 are sleeved on the actuated sleeve valve 4, and together with the coordinated rubber ring segment 11 and the actuated sleeve valve 4 to form the pressure discharge chamber. In some embodiments, both the front conical block 6 and the rear conical block 7 are slidably and fixedly connected to the actuated sleeve valve 4. That is, the front conical block 6 and the rear conical block 7 are constrained in a circumferential direction and a radial direction with respect to the actuated sleeve valve 4 and cannot rotate or move radially, but the front conical block 6 and the rear conical block 7 can slide axially on the actuated sleeve valve 4. The fixed connection manners may include interference fit, or the like.

The connecting spring 8 is sleeved on the outer wall of the actuated sleeve valve 4 and connects the rear conical block 7 and the fixed flow vane 9. In some embodiments, the connecting spring 8 may be used to provide buffer protection for the rear conical block 7.

The fixed flow vane 9 is configured to eliminate the vortex and allow the concrete grout to enter the grouting hole smoothly.

The compressed rubber cap 10 is configured to absorb impact energy, prevent backflow of the concrete grout, and promote mixing uniformity.

The coordinated rubber ring segment 11 is configured to cooperate with the grout discharge chamber to accomplish pressure discharge control. The grout discharge chamber is a pressure cushion chamber. In some embodiments, the grout discharge chamber is configured to receive grout discharge from the primary channel to maintain a stable pressure within the device.

The grout drainage trough 14 refers to a slot hole that is provided on the outer wall of the actuated sleeve valve 4 along the axial direction of the actuated sleeve valve 4. In some embodiments, the grout drainage trough 14 is configured to discharge the concrete grout within the primary channel. The opening size of the grout drainage trough 14 can change with the axial movement of the actuated sleeve valve 4.

More descriptions regarding the device may be found in the related descriptions below.

In some embodiments of the present disclosure, a grout ratio between the primary channel and the secondary channel can be automatically adjusted by the axial displacement of the actuated sleeve valve to adapt to pressure fluctuations in the pressure discharge chamber. The pressure in the pressure discharge chamber can be physically reduced by using the reverse jet flow from the plurality of return claw pipes to offset the grout in the secondary channel. Through the coordinated design of mechanical structure and fluid dynamics, while maintaining grouting efficiency, the inner structural layer can be effectively protected, improving construction quality and safety.

In some embodiments, as shown in FIG. 3, the coordinated blade sets 5 are rotationally connected to the inner wall of the interface pipe 1, the fixed flow vanes 9 are mounted on the inner wall of the interface pipe 1, and the actuated sleeve valve 4 and the fixed flow vanes 9 are slidably connected. The rotational connection is a connection manner that enables relative rotational motion between mechanical parts. Exemplary rotational connection manners may include keyway connections, bearing connections, or the like. In some embodiments, the actuated sleeve valve 4 and the fixed flow vanes 9 are slidably connected may be understood as follows: the actuated sleeve valve 4 can reciprocate along the axial direction of the actuated sleeve valve 4 in an inner hole of the fixed flow vane 9, but there is no relative rotation between the actuated sleeve valve 4 and the fixed flow vanes 9.

It should be noted that the interface pipe 1 provided in some embodiments of the present disclosure is used in conjunction with the grouting jumbo. The interface pipe 1 is installed at the discharge port on the grouting jumbo. According to the tunnel construction requirements, the concrete grout is poured into the inner structural layer in a high-pressure state, and the interface pipe 1 can change autonomously in accordance with the pressure changes during the injection of the concrete grout.

In some embodiments, as shown in FIG. 2, the concrete grout is injected from the left position in FIG. 2 to the right position. In this state, the device utilizes the fluidity and pressure of the concrete grout itself to drive the coordinated blade sets 5 to cooperate and rotate at a high speed. The coordinated blade sets 5 initially reduce the high pressure of the concrete grout by consuming the “self-pressure” of the concrete grout. The interior of the actuated sleeve valve 4 and the interior of each of the plurality of return claw pipes 3 are in the hollow state, so that when the concrete grout is injected directly into the interior of the interface pipe 1, the interior of the actuated sleeve valve 4 may serve as the primary channel, and the interior of the interface pipe 1 may serve as the secondary channel. By changing the structural shape of the plurality of return claw pipes 3, the direction in which the concrete grout flows out of the plurality of return claw pipes 3 is completely opposite to the direction in which the concrete grout flows out of the interface pipe 1. Therefore, the impact process of the two streams of concrete slurries can be utilized to reduce the degree of high-pressure erosion of the inner structural layer by the concrete grout in the high-pressure state.

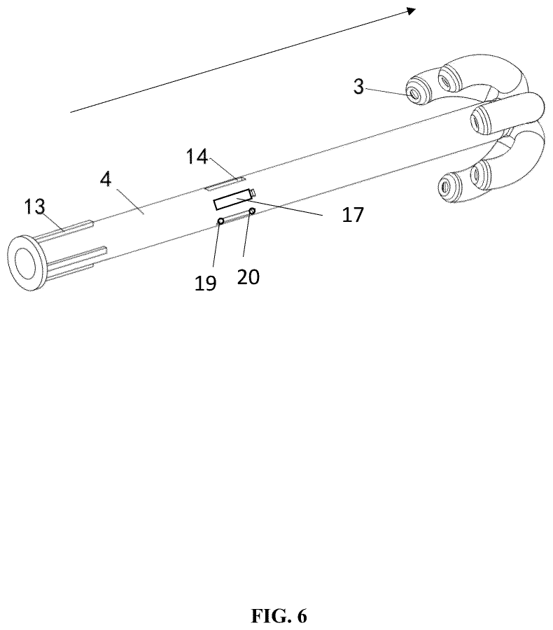

FIG. 6 is a schematic diagram of a structure of an actuated sleeve valve in the pressure-controlled tunnel directional grouting reinforcement device according to some embodiments of the present disclosure.

In some embodiments, as shown in FIG. 4 and FIG. 6, a set of limit strips 13 is mounted on an outer wall of the actuated sleeve valve 4 corresponding to the plurality of coordinated blade sets 5, and the plurality of coordinated blade sets 5 are slidably connected to the actuated sleeve valve 4 through the set of limit strips 1. Cross-sections of the front conical block 6 and the rear conical block 7 are both in a lateral conicalshape, and tip portions of the front conical block 6 and the rear conical block 7 are away from each other. The cross-section refers to a section in a radial direction of the actuated sleeve valve 4.

In some embodiments, the plurality of coordinated blade sets 5 being slidably connected to the actuated sleeve valve 4 through the set of limit strips 13 may be understood as follows: the plurality of coordinated blade sets 5 forms a relatively sliding fit along the axial direction of the actuated sleeve valve 4 with the outer wall of the actuated sleeve valve 4 through the set of limit strips 13, but the plurality of coordinated blade sets 5 are constrained by the set of limit strips 13 in the circumferential and radial directions.

The set of limit strips 13 is configured to limit a radial movement of the actuated sleeve valve 4, ensuring the reliability of the sliding connection between the actuated sleeve valve 4 and the plurality of coordinated blade sets 5. In some embodiments, a count of sets of limit strips 13 provided may be one or more, and a plurality of sets of limit strips 13 may be equally spaced around the circumference of the actuated sleeve valve 4 and extend along the axial direction of the actuated sleeve valve 4.

In some embodiments, the working process of the actuated sleeve valve 4 may include the following steps:

S1: Although the actuated sleeve valve 4 also serves as a flow channel for the concrete grout, the actuated sleeve valve 4 may move from left to right due to the pressure of the concrete grout itself. At the same time, the actuated sleeve valve 4 may also be restricted by the set of limit strips 13. Therefore, the actuated sleeve valve 4 and the coordinated blade sets 5 can maintain both rotation and sliding.

S2: When the concrete grout completely fills the interior of the interface pipe 1 and flows from left to right, the front conical block 6 moves from left to right relative to the rear conical block 7. However, as shown in S1, the movement of the actuated sleeve valve 4 may cause the rear conical block 7 to move from the left to the right relative to the front conical block 6, i.e., the front conical block 6 may undergo a secondary sliding process relative to the rear conical block 7, and the connecting spring 8 is mainly used to provide buffering protection for the rear conical block 7.

S3: The actuated sleeve valve 4 is affected by the high pressure of the concrete grout and eventually moves to the rightmost position. The plurality of return claw pipes 3 and the compressed rubber cap 10 may both extend out of one end of the interface pipe 1. The concrete grout sprayed from the plurality of return claw pipes 3 and the concrete grout sprayed from the interface pipe 1 may impact the compressed rubber cap 10 in both left and right directions. The compressed rubber cap 10 may further withstand the impact of the two streams of concrete slurries, thereby avoiding a large degree of impact or even backflow between the two streams of concrete slurries, thereby ensuring that the two streams of concrete slurries are merged into a relatively low-pressure and stable concrete grout.

In some embodiments of the present disclosure, a connection structure of the actuated sleeve valve is provided so that the actuated sleeve valve can be passively moved during operation, thereby consuming a portion of the concrete grout pressure, ensuring that the two streams of concrete grout are merged into a relatively low-pressure and stable concrete grout, and reducing the damage caused by high-pressure erosion of the concrete grout on the inner structural layer.

In some embodiments, as shown in FIG. 3 to FIG. 4, the interface pipe 1, along a direction from the coordinated blade sets 5 to the plurality of return claw pipes 3, is provided with an injection port 101 and a discharge port 102, respectively. A pressure coupled cylinder 2 corresponding to the grout discharge chamber is mounted on an outer position of the interface pipe 1, an output shaft end of the pressure coupled cylinder 2 extends into the interface pipe 1, passive pressure blocks 12 are mounted on the output shaft end of the pressure coupled cylinder 2, the passive pressure blocks 12 are arranged at a middle position of the coordinated rubber ring segment 11, and the passive pressure blocks 12 are arranged in an annular array around a center point of the actuated sleeve valve 4.

The pressure coupled cylinder 2 is an integrated execution unit composed of a group of hydraulic cylinders (or pneumatic cylinders) connected in parallel, driven by a unified pressure oil (or compressed air) source, which can generate thrust/tension simultaneously or sequentially to achieve “linked operation” or “multi-point synchronous pressurization”. In some embodiments, the pressure coupled cylinder 2 may be used to provide controllable thrust to push the passive pressure block 12 to squeeze the coordinated rubber ring segment 11.

The passive pressure block 12 is configured to squeeze the coordinated rubber ring segment 11. In some embodiments, the passive pressure blocks 12 are arranged in the annular array around the center point of the actuated sleeve valve 4, which can be understood as: the passive pressure blocks 12 are evenly distributed circumferentially along the center point of the actuated sleeve valve 4. Such an arrangement is beneficial to ensure that the coordinated rubber ring segment 11 is evenly stressed and avoids uneven wear. It should be noted that a count of the passive pressure blocks 12 can be determined according to the actual demand.

In some embodiments, the concrete grout poured into the interface pipe 1 is divided into two parts, a portion of the concrete grout is discharged along the actuated sleeve valve 4. Since this portion does not undergo any structural “consumption process”, it can be set as a high-pressure portion. The other portion of the concrete grout is discharged from the middle position between the actuated sleeve valve 4 and the interface pipe 1. Since the other portion of the concrete grout passes through the cooperation of the front conical block 6, the rear conical block 7, and the coordinated blade sets 5, the pressure of the other portion of the concrete grout is slightly lower than that of the high-pressure portion. The other portion of the concrete grout is set as a low-pressure portion.

In some embodiments, although the concrete grout in the high-pressure portion is directly discharged through the plurality of return claw pipes 3, the concrete grout in the high-pressure portion may be completely filled in the grout discharge chamber through the grout drainage trough 14 during the flow process, thereby causing the coordinated rubber ring segment 11 to present an expanding oblique edge outward state. Since the pressure of the concrete grout in the low-pressure portion is less than the pressure of the concrete grout in the high-pressure portion, the coordinated rubber ring segment 11 directly presents an outwardly expanded state. Moreover, the front conical block 6 may also be subjected to the pressure from the concrete grout and move toward the right side, further squeezing the grout discharge chamber and reducing the internal volume of the grout discharge chamber.

In some embodiments, if only the interior of the actuated sleeve valve 4 is allowed to flow with concrete grout, the front conical block 6 and the rear conical block 7 may move away from each other to a maximum extent, and the coordinated rubber ring segment 11 may also become fully expanded and deformed. However, in actual situations, the front conical block 6 may undergo secondary sliding, further affecting the expansion and deformation degree of the coordinated rubber ring segment 11, as shown in FIG. 3. By limiting the expansion and deformation degree of the coordinated rubber ring segment 11, the discharge process of the concrete grout of the low-pressure portion is changed. That is, by increasing or decreasing the pressure through the pressure coupled cylinder 2, the pressure changes of the pressure coupled cylinder 2 can change the expansion and deformation degree of the coordinated rubber ring segment 11, thereby inversely controlling the specific pressure of the concrete grout of the low-pressure portion when the low-pressure portion is discharged from the interface pipe 1. For example, when the pressure coupled cylinder 2 is periodically pressurized or depressurized, the pressure of the pressure coupled cylinder 2 in the low-pressure portion is reduced and then increased, which can ensure that the pressure of the concrete grout discharged from the plurality of return claw pipes 3 is in a relatively stable and low-pressure state, thereby ensuring that the pressure of the concrete grout in the low-pressure portion and the high-pressure portion is relatively consistent.

In some embodiments of the present disclosure, the pressure coupled cylinder and the coordinated rubber ring segment work together to achieve real-time pressure balance between the low-pressure portion and the high-pressure portion, which is beneficial to ensure the stability of concrete grout injection.

In some embodiments, as shown in FIG. 2, the device further includes a flexible sensor 15 and a processor 16. The flexible sensor 15 is configured to detect a degree of surface deformation of the coordinated rubber ring segment 11. The processor is configured to: determine a pressure difference based on the degree of surface deformation; determine a pressure value for active pressure compensation based on the pressure difference; and trigger the pressure coupled cylinder 2 to perform the active pressure compensation based on the pressure value.

The flexible sensor 15 is made of a flexible material. For example, the flexible sensor 15 may include a thin film strain sensor, a thin film capacitive sensor, or the like. In some embodiments, the flexible sensor 15 may be disposed at a location capable of detecting the deformation of the coordinated rubber ring segment 11. For example, as shown in FIG. 2, the flexible sensor 15 may be affixed to a surface of the coordinated rubber ring segment 11.

The degree of surface deformation of the coordinated rubber ring segment 11 refers to the local or overall deformation amount of an outer surface of the coordinated rubber ring segment 11 relative to its stress-free reference state. In some embodiments, the degree of surface deformation may be characterized by a normal displacement. The normal displacement refers to a change in the perpendicular distance from a designated point on the outer surface of the coordinated rubber ring segment 11 to its initial position. In some embodiments, the degree of surface deformation may also be characterized by a change in curvature of the coordinated rubber ring segment 11.

The processor may process data and/or information obtained from other components of the device or equipment. The processor may execute program instructions based on such data, information, and/or processing results to perform one or more of the functions described in the present disclosure. In some embodiments, the processor may include one or more sub-processing devices (e.g., a single-core processing device or a multi-core processing device). Merely by way of example, the processor may include a central processing unit (CPU), an application specific instruction processor (ASIP), a controller, a microcontroller unit, a microprocessor, or the like, or any combination thereof. In some embodiments, the processor may be a remote server.

The pressure difference refers to a pressure difference value between an inside and outside of the coordinated rubber ring segment 11. If internal pressure of the coordinated rubber ring segment 11 is greater than external pressure of the coordinated rubber ring segment 11, the pressure difference is positive; if the internal pressure of the coordinated rubber ring segment 11 is less than the external pressure of the coordinated rubber ring segment 11, the pressure difference is negative.

The processor may determine the pressure difference based on the degree of surface deformation in a plurality of ways. In some embodiments, the processor may determine the pressure difference based on the degree of surface deformation by querying a first preset table. The first preset table includes a plurality of sets of correspondences between the degree of surface deformation and the pressure difference. In some embodiments, the first preset table may be constructed based on experimental data.

The active pressure compensation may be understood as pressurizing or depressurizing the grout discharge chamber to change the pressure difference between the inside and outside of the coordinated rubber ring segment 11. In some embodiments, the active pressure compensation may be achieved by the pressure coupled cylinder 2.

The pressure value of the active pressure compensation is a vector, which reflects a magnitude and direction of pressure of the active pressure compensation. If the pressure value is positive, then the pressure coupled cylinder 2 may pressurize the grout discharge chamber based on the magnitude of the pressure, i.e., push the passive pressure blocks 12 to squeeze the coordinated rubber ring segment 11, thereby reducing an internal space of the grout discharge chamber. Conversely, if the pressure value is negative, the pressure coupled cylinder 2 may depressurize the grout discharge chamber based on the magnitude of the pressure, i.e., pull the passive pressure blocks 12 to allow the coordinated rubber ring segment 11 to expand and deform, increasing the internal space of the grout discharge chamber.

The processor may determine the pressure value for the active pressure compensation based on the pressure difference in a plurality of ways. In some embodiments, the processor may determine the pressure value based on the pressure difference by querying a second preset table. The second preset table includes a plurality of correspondences between the pressure difference and the pressure value. In some embodiments, the second preset table may be preset based on experience, or constructed based on historical data. For example, the processor may filter the historical data and select a plurality of sets of historical data corresponding to the situation when the device continues to be available (such as the continuous use time exceeds a preset duration), the working efficiency is not reduced and no failure occurs after the active pressure compensation, to construct the second preset table. The preset duration may be set by a technician in advance.

More descriptions regarding how the processor determines the pressure value for the active pressure compensation may be found in the related descriptions below.

In some embodiments, the processor can automatically trigger the pressure coupled cylinder 2 to perform the active pressure compensation based on the pressure value through a first preset program based on the pressure value. Merely by way of example, the processor may control the pressure coupled cylinder 2 to pressurize or depressurize the grout discharge chamber based on the pressure value. In some embodiments, the first preset program may be set by a skilled person in advance.

More descriptions regarding the pressure coupled cylinder may be found elsewhere in the present disclosure (e.g., FIG. 3 to FIG. 4 and related descriptions thereof).

In some embodiments of the present disclosure, the pressure difference is determined based on the degree of surface deformation of the coordinated rubber ring segment to determine the pressure value of the active pressure compensation. The active pressure compensation is performed based on the pressure value via the pressure coupled cylinder. The active pressure compensation can limit the degree of deformation of the coordinated rubber ring segment, thereby facilitating further variation of the pressure state of the concrete grout during discharge, and ensuring that the two streams of concrete grout can be mixed into one stream of low-pressure and stable concrete grout.

In some embodiments, the processor is further configured to: determine a pressure difference of a future time period based on a degree of surface deformation of a first time period; and determine the pressure value based on the pressure difference of the future time period.

The first time period refers to a time period of history. In some embodiments, the length of the first time period may be preset by the technician.

In some embodiments, the length of the first time period correlates to a blockage rate of a second time period.

The second time period refers to a time period in the future. In some embodiments, the length of the second time period may be preset by the technician. The length of the second time period may be the same as or different from the length of the first time period.

The blockage rate of the second time period refers to probability that the grout drainage trough 14 is blocked during the second time period. More descriptions regarding the blockage rate may be found in the related descriptions below.

In some embodiments, the length of the first time period may be negatively correlated with the blockage rate of the second time period. It is understandable that if the blockage rate of the second time period continues to rise, the pressure difference inside the device (such as the grout discharge chamber) may be too high, which may easily cause the device to explode. Therefore, it is necessary to shorten the length of the first time period and increase the monitoring frequency to enable more detailed monitoring. In some embodiments, the processor may determine whether the blockage rate of the second time period continues to increase by performing a linear fit to the blockage rate of the second time period. For example, if a slope of the second time period is positive, it is determined that the blockage rate continues to increase. In the linear fit, time is an independent variable and the blockage rate is a dependent variable.

The degree of surface deformation of the first time period refers to a plurality of degrees of surface deformation of the coordinated rubber ring segment 11 at a plurality of time points in the first time period. In some embodiments, the processor may obtain the degree of surface deformation of the first time period by counting the degree of surface deformation of the coordinated rubber ring segment 11 detected by the flexible sensor 15 during the first time period.

The future time period refers to a time period after the current moment. In some embodiments, the length of the future time period may be preset by the technician. The future time period may be the same as or different from the second time period.

The pressure difference of the future time period refers to a plurality of pressure differences between the inside and the outside of the coordinated rubber ring segment 11 at a plurality of time points during the future time period.

In some embodiments, the processor may determine, based on the degree of surface deformation of the first time period, the pressure difference of the future time period via a pressure difference determination model.

The pressure difference determination model refers to a model for determining the pressure difference. In some embodiments, the pressure difference determination model may be a machine learning model. For example, the pressure difference determination model may include a recurrent neural networks (RNN) model, or the like, or any one or combination of other customized model structures.

In some embodiments, an input of the pressure difference determination model may include the degree of surface deformation of the first time period, and an output of the pressure difference determination model may include the pressure differences of the future time periods.

In some embodiments, the pressure difference determination model may be obtained by training based on a plurality of first training samples with first labels.

In some embodiments, the first training samples may include sample degrees of surface deformation of a first historical time period. The first labels include actual pressure differences of a second historical time period corresponding to the first training sample.

In some embodiments, the first training samples and the first labels may be determined based on the historical data. For example, the processor may sort the historical data in a chronological order, use a plurality of degrees of surface deformation of the first historical time period in the historical data as the first training samples, and use the actual pressure differences of the second historical time period in the historical data as the first labels. The first historical time period precedes the second historical time period.

In some embodiments, the processor may input the plurality of first training samples into an initial pressure difference determination model, obtain an output of the initial pressure difference determination model. The processor may substitute the first labels and the output into a preset loss function, and iteratively update the parameters of the initial pressure difference determination model based on the value calculated by the loss function using gradient descent or other manners. When a preset condition is met, the training of the initial pressure difference determination model is completed, and the pressure difference determination model is obtained. The preset condition may be that the loss function converges, the number of iterations reaches a threshold, or the like

In some embodiments, the processor may calculate a mean value of the pressure difference of the future time period based on the pressure difference of the future time period, and then determine, based on the mean value, the pressure value by querying the second preset table. More descriptions regarding the second preset table may be found in the related descriptions below.

In some embodiments of the present disclosure, outputting the pressure difference of the future time period through a trained machine learning model and determining the pressure value based on the pressure difference of the future time period enables prediction of the pressure value and improves the accuracy and efficiency of determining the pressure value.

In some embodiments, the processor is further configured to: determine the pressure value based on a pressure sequence, an opening size of the grout drainage trough, and the pressure difference.

The pressure sequence refers to a sequence consisting of a plurality of pieces of pressure data at a certain time point. In some embodiments, the pressure data may be obtained by a plurality of pressure sensors disposed inside the device.

The pressure sensor refers to a device or apparatus that can sense pressure signals and convert the pressure signals into usable output electrical signals according to certain rules. For example, the pressure sensor may include a piezoresistive pressure sensor, a capacitive pressure sensor, or the like. In some embodiments, the pressure sensor may be disposed at a plurality of location points within the device to detect the pressures applied to the plurality of location points within the device. For example, the pressure sensors may be disposed within the interior of the grout discharge chamber or at the entrances and exits of the grout drainage trough 14, etc.

The opening size of the grout drainage trough 14 refers to a size of the slot hole of the grout drainage trough 14. In some embodiments, the opening size of the grout drainage trough 14 may be determined based on actual needs. In some embodiments, the opening size of the grout drainage trough 14 may be variable. More descriptions regarding the opening size of the grout drainage trough may be found in the related descriptions below.

In some embodiments, the processor may determine the pressure value by querying a third preset table based on the pressure sequence, the opening size of the grout drainage trough, and the pressure difference.

The second preset table includes a plurality of correspondences between the pressure sequence, the opening size of the grout drainage trough, the pressure difference, and the pressure value. In some embodiments, the third preset table may be constructed based on the experience or the historical data.

In some embodiments of the present disclosure, by taking into account the pressure sequence, the opening size of the grout drainage trough, a determined pressure value can better conform to the actual situation, thereby facilitating an improvement in the precision of the pressure value.

In some embodiments, as shown in FIG. 5 to FIG. 6, the grout drainage trough 14 is provided with a movable plate 17, the movable plate 17 adjusts the opening size by varying a coverage area over the grout drainage trough 14. An interior of the grout discharge chamber is provided with the pressure sensor 18. The pressure sensor 18 is configured to detect a pressure of the grout discharge chamber. The opening size is determined based on the pressure of the grout discharge chamber and a grout viscosity.

The movable plate 17 refers to a member for covering the grout drainage trough 14. In some embodiments, the movable plate 17 is disposed corresponding to the grout drainage trough 14 and is disposed on the actuated sleeve valve 4 along the axial direction of the actuated sleeve valve 4. In some embodiments, the movable plate 17 may be a telescoping plate detachably engaged within the grout drainage trough 14. The movable plate 17 can vary the coverage area over the grout drainage trough 14 through its own telescoping or movement, thereby adjusting the opening size of the grout drainage trough 14. For example, the movable plate 17 may be connected to a motor, and the processor may control the telescoping or movement of the movable plate 17 by controlling the motor.

The pressure of the grout discharge chamber refers to a pressure inside the grout discharge chamber. In some embodiments, the pressure of the grout discharge chamber may be obtained by the pressure sensor 18 disposed inside the grout discharge chamber. More descriptions regarding the pressure sensor may be found in the related descriptions above.

The grout viscosity refers to an internal friction property of the grout (e.g., the concrete grout) that resists flow under an applied external force. In some embodiments, the grout viscosity may be set in advance by the skilled person. In some embodiments, the grout viscosity may also be obtained by a viscometer.

In some embodiments, the opening size of the grout drainage trough 14 may be positively correlated with the pressure of the grout discharge chamber and/or the grout viscosity. For example, the greater the pressure of the grout discharge chamber is, the greater the opening size of the grout drainage trough 14 is. As another example, the greater the grout viscosity is, the greater the opening size of the grout drainage trough 14 is.

It is understandable that if the pressure of the grout discharge chamber is higher, the grout discharge chamber may need to backflow toward the actuated sleeve valve 4. It is necessary to increase the opening size of the grout drainage trough 14 to allow such backflow to occur. The higher the viscosity of the grout viscosity is, the greater the tendency for the concrete grout to block the grout drainage trough 14. It is necessary to increase the opening size of the grout drainage trough 14 to ensure smooth flow of the concrete grout between the grout discharge chamber and the interior of the actuated sleeve valve 4.

In some embodiments of the present disclosure, the opening size is determined based on the pressure of the grout discharge chamber and the grout viscosity. This allows for adaptive adjustment of the opening size of the grout drainage trough, thereby ensuring the proper operation of the normal flow and backflow of the concrete grout.

In some embodiments, as shown in FIG. 6, a first flow meter 19 is arranged at an inlet of the grout drainage trough 14, the first flow meter 19 is configured to detect a grout inflow volume, a second flow meter is arranged at an outlet of the grout drainage trough 14, the second flow meter 20 is configured to detect a grout discharge volume. The processor is further configured to determine the blockage rate of the grout drainage trough 14, the grout inflow volume, and the grout discharge volume. In response to determining that the blockage rate exceeds a blockage rate threshold, issue a cleanup warning. In response to determining that the blockage rate does not exceed the blockage rate threshold, determine the opening size based on the grout inflow volume, the grout discharge volume, the pressure of the grout discharge chamber, and the grout viscosity.

The first flow meter 19 is configured to detect the grout inflow volume. The grout inflow volume refers to the flow volume of the grout injected from the inlet of the grout drainage trough 14. In some embodiments, the first flow meter 19 is arranged at the inlet of the grout drainage trough 14. The inlet of the grout drainage trough 14 refers to an upstream end of the grout drainage trough 14 along a direction of the grout flow. As shown in FIG. 6, the direction of the grout flow may be the direction indicated by the arrow.

The second flow meter 20 is configured to detect the grout discharge volume. The grout discharge volume refers to the flow volume of the grout discharged from the outlet of the grout drainage trough 14. In some embodiments, the second flow meter 20 is arranged at the outlet of the grout drainage trough 14. The outlet of the grout drainage trough 14 is a downstream end of the grout drainage trough 14 along a direction of the grout flow.

The blockage rate is the probability that the grout drainage trough 14 is blocked. In some embodiments, the processor may determine the blockage rate of the grout drainage trough based on the grout inflow volume and the grout discharge volume. Exemplary calculation formulas include:

blockage rate=k*grout inflow volume/(grout inflow volume−grout discharge volume+α) (1)

k denotes an empirical coefficient, dimensionless, and α denotes a decimal to prevent the denominator from being 0, and its unit is the same as the grout inflow volume and the grout discharge volume. In some embodiments, k and α may be preset by the skilled person.

More descriptions regarding how the processor determines the blockage rate of the grout drainage trough may be found in the related descriptions below.

The blockage rate threshold refers to a preset alarm threshold. For example, the blockage rate threshold may be 20%, or the like.

In some embodiments, the blockage rate threshold correlates to a moving range of the movable plate 17 and the grout viscosity. For example, the blockage rate threshold may be positively correlated with the moving range of the movable plate 17. The greater the moving range of the movable plate 17 is, the greater the blockage rate threshold is. As another example, the blockage rate threshold may be negatively correlated with the grout viscosity. The lower the grout viscosity is, the lower the blockage rate threshold is.

The moving range of the movable plate 17 refers to the maximum effective stroke of the movable plate 17 that can be slid on the grout drainage trough 14. In some embodiments, the moving range may be represented by 0 to 1. The moving range correlates to the coverage area that the grout drainage trough 14 is covered by the movable plate 17. For example, if the coverage area is 0 (i.e., the grout drainage trough 14 is not covered), the moving range of the movable plate 17 is 0. If the coverage area is the entire area of the grout drainage trough 14, the moving range of the movable plate 17 is 1.

It is understandable that if the movable plate 17 has a larger movable range, the operable range that can be adjusted to reduce blockage is larger, and a blockage rate threshold value causing blockage of the grout drainage trough 14 is higher. Similarly, if the grout viscosity is smaller, the concrete grout is less likely to be blocked at the slot hole of the grout drainage trough 14, the concrete grout flows more smoothly, and the blockage rate threshold value causing blockage of the grout drainage trough 14 is higher.

The cleanup warning refers to an early warning signal used to remind a user to clean the grout drainage trough 14. For example, early warning forms of the cleanup warning include, but are not limited to, a pop-up window, a beep, or the like.

In some embodiments, there may be scenarios where the blockage rate either exceeds or does not exceed the blockage rate threshold.

In some embodiments, in response to determining that the blockage rate exceeds the blockage rate threshold, the processor may automatically issue the cleanup warning via the second preset program. The second preset program may be set by the technician in advance.

More descriptions regarding the processor issuing the cleanup warning may be found in the related descriptions below.

In some embodiments, in response to determining that the blockage rate does not exceed the blockage rate threshold, the processor may determine the opening size by querying a fourth preset table based on the grout inflow volume, the grout discharge volume, the pressure of the grout discharge chamber, and the grout viscosity.

In some embodiments, the fourth preset table includes a plurality of sets of correspondences between the grout inflow volume, the grout discharge volume, the pressure of the grout discharge chamber, the grout viscosity, and the opening size. The fourth preset table may be constructed based on the experience or the historical data.

In some embodiments, the processor may control the motor to drive the movable plate 17 to telescope or move based on a determined opening size (referred to as a target opening size) to change the coverage area cover the grout drainage trough 14, thereby adjusting the opening size of the grout drainage trough 14 to the target opening size.

In some embodiments of the present disclosure, by predicting the blockage situation and sending the cleanup warning to the user, the user can know the blockage situation of the grout drainage trough in advance and clean it in time. Determining the opening size of the grout drainage trough based on the grout inflow volume, the grout discharge volume, the pressure of the grout discharge chamber, and the grout viscosity can ensure that the opening size of the grout drainage trough is set more reasonably to adapt to the actual situation of the grout flow and reduce the blockage rate.

In some embodiments, the processor is further configured to determine the blockage rate of the second time period based on a grout inflow volume of a third time period, a grout discharge volume of the third time period, and an opening size of the third time period. The processor is further configured to determine a warning time point based on the blockage rate of the second time period and the blockage rate threshold, and issue the cleanup warning at the warning time point.

The third time period refers to a time period of history. In some embodiments, the length of the third time period may be preset by the technician. The third time period may be the same as or different from the first time period.

The grout inflow volume of the third time period refers to the flow volume of the grout injected from the inlet of the grout drainage trough 14 at a plurality of time points during the third time period. In some embodiments, the processor may obtain the grout inflow volume of the third time period by counting a plurality of grout inflow volumes detected by the first flow meter 19 during the third time period.

The grout discharge volume of the third time period refers to the flow volume of the grout discharged from the outlet of the grout drainage trough 14 at a plurality of time points during the third time period. In some embodiments, the processor may obtain the grout discharge volume of the third time period by counting a plurality of grout discharge volumes detected by the second flow meter 20 during the third time period.

The opening size of the third time period refers to the opening size of the grout drainage trough 14 at a plurality of time points during the third time period. In some embodiments, the processor may record and store in real time a motor encoder value of the motor for driving the telescoping or movement of the movable plate 17. There is a mapping relationship between the motor encoder value and the opening size of the grout drainage trough 14. The processor may obtain the opening size of the third time period by retrieving a plurality of motor encoder values during the third time period, and based on the mapping relationship. The mapping relationship may be determined through experiments or the historical data.

In some embodiments, the processor may determine the blockage rate of the second time period via a blockage rate determination model based on the grout inflow volume of the third time period, the grout discharge volume of the third time period, and the opening size of the third time period.

The blockage rate determination model refers to a model for determining the blockage rate. In some embodiments, the blockage rate determination model may be a machine learning model. For example, the blockage rate determination model may include the RNN model, a deep neural network (DNN) model, or the like, or any one or combination of other customized model structures.

In some embodiments, inputs of the blockage rate determination model may include the grout inflow volume of the third time period, the grout discharge volume of the third time period, and the opening size of the third time period, and outputs of the blockage rate determination model may include the blockage rate of the second time period.

In some embodiments, the blockage rate determination model may be obtained by training a plurality of second training samples with second labels. The second training samples may include a sample grout inflow volume, a sample grout discharge volume, and a sample opening size of the first historical time period. The second labels include actual blockage rates of the second historical time period corresponding to the second training sample.

In some embodiments, the second training samples and the second labels may be determined based on the historical data. For example, the processor may sort the historical data in a chronological order, use a plurality of grout inflow volumes, a plurality of grout discharge volumes, and a plurality of opening sizes of the first historical time period in the historical data as the second training sample, and use the actual blockage rates of the second historical time period in the historical data as the second labels. The first historical time period precedes the second historical time period. In some embodiments, the processor may use the blockage rate calculated by the equation (1) in the historical data as the actual blockage rate.

It should be noted that the training manner of the blockage rate determination model is similar to the training manner of the pressure difference determination model, which may not be repeated here.

More descriptions regarding the blockage rate may be found in the related descriptions above.

The warning time point refers to a time point when the processor issues the cleanup warning. In some embodiments, the processor may determine the warning time point based on the blockage rate of the second time period and the blockage rate threshold, and in response to determining that the blockage rate exceeds the blockage rate threshold, issue the cleanup warning at the warning time point. For example, the processor may filter the blockage rate of the second time period, filter out the earliest time point when the blockage rate exceeds the blockage rate threshold, and use the earliest time point as the warning time point. The preset duration may be preset based on the experience.

In some embodiments of the present disclosure, by determining the warning time point for issuing the cleanup warning, it is helpful to promptly remind the user to clean up the grout drainage trough according to the blockage situation that is predicted, thereby ensuring that the grout drainage trough works smoothly.

The beneficial effects of the pressure-controlled tunnel directional grouting reinforcement device provided in the embodiments of the present disclosure include but are not limited to:

Improvements and optimizations are made to the grouting jumbo used in tunnel grouting operations. An interface pipe structure is proposed to cooperate with grouting. The interface pipe does not change an injection state of the concrete grout in essence. The grouting manner of high-pressure in and low-pressure out is maintained during the overall grouting process. The pressure generated during the concrete injection serves as a power source, thereby forcing the front conical block, the rear conical block, and the actuated sleeve valve inside the interface pipe to move directionally, maintaining the concrete grout in the high-pressure state during injection. The passive movement of a plurality of structures dissipates a portion of the concrete grout pressure. The impact of the two streams of concrete grout reduces the degree of the high-pressure erosion on the inner structural layer by the concrete grout in the high-pressure state. Consequently, the concrete grout is injected into the inner structural layer at a relatively low-pressure and stable state, thereby reducing the damage caused by the high-pressure erosion on the inner structural layer by the concrete grout.

To reduce the damaging effects of the high-pressure erosion on the inner structural layer by the concrete grout, the active pressure compensation is further employed to interfere with a pressure fluctuation state of the concrete grout. That is, by matching the front conical block and the rear conical block between the coordinated rubber ring segment by the two parts of the concrete grout pressure by the degree of compressive deformation, the coordinated rubber ring segment undergoes different degrees of compressive deformation under the two streams of the concrete grout pressure. The passive pressure block serving an interference role is added based on the degree of compressive deformation. The coordinated rubber ring segment works with the front conical block and the rear conical block to bear a dual pressure. When the coordinated rubber ring segment deforms under the dual pressure, the active pressure compensation is employed to further restrict the degree of deformation of the coordinated rubber ring segment. This further varies a pressure change of the concrete grout, thereby enabling the two streams of concrete grout to be “mixed into” one stream of relatively low-pressure and stable concrete grout.

In addition, the pressure difference is determined based on the degree of surface deformation of the coordinated rubber ring segment to determine the pressure value of the active pressure compensation. The active pressure compensation is performed based on the pressure value via the pressure coupled cylinder. The active pressure compensation can limit the degree of deformation of the coordinated rubber ring segment, thereby facilitating further varying the pressure state of the concrete grout during discharge, and ensuring that the two streams of concrete grout can be mixed into one stream of low-pressure and stable concrete grout.

The basic concepts have been described above, and it is apparent to those skilled in the art that the foregoing detailed disclosure serves only as an example and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

What is claimed is:

1. A pressure-controlled tunnel directional grouting reinforcement device, applied in a grouting jumbo, comprising an interface pipe, wherein an actuated sleeve valve is provided at a center of an interior of the interface pipe, coordinated blade sets and fixed flow vanes are provided in an inner wall of the interface pipe, respectively;
an end of the actuated sleeve valve away from the coordinated blade sets extends to an outside of the interface pipe, a plurality of return claw pipes are mounted on the end of the actuated sleeve valve away from the coordinated blade sets, both an interior of the actuated sleeve valve and an interior of each of the plurality of return claw pipes are in a hollow state, both ends of the actuated sleeve valve and each of the plurality of return claw pipes are configured with open ports, an intermediate portion of the actuated sleeve valve, located between the coordinated blade sets and the fixed flow vanes, is mounted with a front conical block and a rear conical block respectively, a coordinated rubber ring segment corresponding to the actuated sleeve valve is mounted between the front conical block and the rear conical block, an outer position of the actuated sleeve valve corresponding to the coordinated rubber ring segment is configured as a grout discharge chamber, a grout drainage trough is arranged on an outer wall of the actuated sleeve valve corresponding to the grout discharge chamber; and
the front conical block and the rear conical block are sequentially arranged along a direction from the coordinated blade sets to the plurality of return claw pipes, both the front conical block and the rear conical block are slidably and fixedly connected to the actuated sleeve valve, a connecting spring is arranged on an outer position of the actuated sleeve valve between the rear conical block and the fixed flow vanes, a radial dimension of the front conical block and a radial dimension of the rear conical block are smaller than an inner diameter of the interface pipe, each of the plurality of return claw pipes bent in a reverse direction toward the interface pipe, a compressed rubber cap is mounted on a position of the actuated sleeve valve that is between the fixed flow vanes and the plurality of return claw pipes, a cross-section of the compressed rubber cap is curved in an arch shape, and the compressed rubber cap is curved toward the plurality of return claw pipes.

2. The pressure-controlled tunnel directional grouting reinforcement device according to claim 1, wherein the coordinated blade sets are rotationally connected to the inner wall of the interface pipe, the fixed flow vanes are mounted on the inner wall of the interface pipe, and the actuated sleeve valve and the fixed flow vanes are slidably connected.

3. The pressure-controlled tunnel directional grouting reinforcement device according to claim 2, wherein a set of limit strips is mounted on an outer wall of the actuated sleeve valve corresponding to the plurality of coordinated blade sets, and the plurality of coordinated blade sets are slidably connected to the actuated sleeve valve through the set of limit strips.

4. The pressure-controlled tunnel directional grouting reinforcement device according to claim 1, wherein cross-sections of the front conical block and the rear conical block are both in a lateral conical shape, and tip portions of the front conical block and the rear conical block are away from each other.

5. The pressure-controlled tunnel directional grouting reinforcement device according to claim 1, wherein the interface pipe, along a direction from the coordinated blade sets to the plurality of return claw pipes, is provided with an injection port and a discharge port, respectively.

6. The pressure-controlled tunnel directional grouting reinforcement device according to claim 1, wherein a pressure coupled cylinder corresponding to the grout discharge chamber is mounted on an outer position of the interface pipe, an output shaft end of the pressure coupled cylinder extends into the interface pipe, passive pressure blocks are mounted on the output shaft end of the pressure coupled cylinder, the passive pressure blocks are arranged at a middle position of the coordinated rubber ring segment, and the passive pressure blocks are arranged in an annular array around a center point of the actuated sleeve valve.

7. The pressure-controlled tunnel directional grouting reinforcement device according to claim 6, further comprising a flexible sensor and a processor, the flexible sensor being configured to detect a degree of surface deformation of the coordinated rubber ring segment;
wherein the processor is configured to:
determine a pressure difference based on the degree of surface deformation;
determine a pressure value for active pressure compensation based on the pressure difference; and
trigger the pressure coupled cylinder to perform the active pressure compensation based on the pressure value.

8. The pressure-controlled tunnel directional grouting reinforcement device according to claim 7, wherein the processor is further configured to:
determine a pressure difference of a future time period based on a degree of surface deformation of a first time period; and
determine the pressure value based on the pressure difference of the future time period; wherein a time length of the first time period correlates to a blockage rate of a second time period.

9. The pressure-controlled tunnel directional grouting reinforcement device according to claim 7, wherein the processor is further configured to:
determine the pressure value based on a pressure sequence, an opening size of the grout drainage trough, and the pressure difference.

10. The pressure-controlled tunnel directional grouting reinforcement device according to claim 7, wherein the grout drainage trough is provided with a movable plate, the movable plate adjusting the opening size by varying a coverage area over the grout drainage trough; and
an interior of the grout discharge chamber is provided with a pressure sensor, the pressure sensor being configured to detect a pressure of the grout discharge chamber, the opening size being determined on the pressure of the grout discharge chamber and a grout viscosity.

11. The pressure-controlled tunnel directional grouting reinforcement device according to claim 10, wherein a first flow meter is arranged at an inlet of the grout drainage trough, the first flow meter is configured to detect a grout inflow volume, a second flow meter is arranged at an outlet of the grout drainage trough, the second flow meter is configured to detect a grout discharge volume;
the processor is further configured to:
determine a blockage rate of the grout drainage trough based on the grout inflow volume and the grout discharge volume;
in response to determining that the blockage rate exceeds a blockage rate threshold, issue a cleanup warning; and
in response to determining that the blockage rate does not exceed the blockage rate threshold, determine the opening size based on the grout inflow volume, the grout discharge volume, the pressure of the grout discharge chamber, and the grout viscosity; wherein the blockage rate threshold correlates to a moving range of the movable plate and the grout viscosity.

12. The pressure-controlled tunnel directional grouting reinforcement device according to claim 11, wherein the processor is further configured to:
determine a blockage rate of the second time period based on a grout inflow volume of a third time period, a grout discharge volume of the third time period, and an opening size of the third time period; and
determine a warning time point based on the blockage rate of the second time period and the blockage rate threshold, and issue the cleanup warning at the warning time point.
